(19) United States
(12) Patent Application Publication
(10) Pub. No.: US 2017/0359172 A1
(43) Pub. Date: Dec. 14, 2017

(54) SECURITY FOR MONITORING AND DETECTION SYSTEMS

(71) Applicant: ESMART TECH, INC., San Diego, CA (US)

(72) Inventors: Li Chen, Beijing (CN); Kenny Fok, San Diego, CA (US); David Diplock, Alpine, CA (US); Niral Bhalodia, San Diego, CA (US); Ying Xiong, San Diego, CA (US)

(21) Appl. No.: 15/616,912

(22) Filed: Jun. 7, 2017

Related U.S. Application Data
(60) Provisional application No. 62/350,152, filed on Jun. 14, 2016.

(51) Int. Cl. H04L 9/08; H04W 76/02; H04L 9/14

(52) U.S. Cl. CPC H04L 9/0891; H04L 9/14; H04W 76/02; H04L 9/0819; H04L 9/085; H04L 9/0861; H04L 2209/80

(57) ABSTRACT

A detection and monitoring system includes: at least one host; and a plurality of detection modules, where the at least one host and the plurality of detection modules communicate across an encrypted channel using a shared key. An automated method that provides secure communications includes: receiving, at a detection module, a session request message sent from a host; sending, from the detection module to the host, a session create message; and receiving, at the detection module, a session accept message sent from the host. An automated method of enabling communication in a detection and monitoring system includes: identifying, at a server, a set of detection modules; identifying, at the server, a set of hosts; generating, at the server, an updated secret shared key; and pushing the updated shared secret key from the server to the set of detection modules and the set of hosts using an encrypted channel.

### CROSS-REFERENCE TO RELATED APPLICATIONS

This application claims priority to U.S. Provisional Patent Application Ser. No. 62/350,152, filed on Jun. 14, 2016.

### BACKGROUND

Many industrial and consumer systems use a variety of detection modules or sensors (e.g., air quality detection modules).

In some cases, manufacturers may tamper with measurements or other data such that products appear to have better performance than is actually delivered. In such cases, a vendor (or other interested party) may wish to disable operation of detection modules in the products identified as sub-standard.

Therefor there exists a need for a way to remotely enable or disable various detection modules.

### SUMMARY

Some embodiments provide ways to securely communicate across detection and monitoring systems, such as air quality detection and monitoring systems.

The systems may include a number of air quality detection modules (AQDMs), and/or other types of detection modules. One or more hosts may communicate with the AQDMs. Such communication may utilize shared keys for security.

In some embodiments, a shared keys may be periodically updated based on some relevant criteria. For instance, a set of AQDMs (e.g., those associated with a particular manufacturer or vendor) may be found to provide invalid information. In such cases, the shared security key of each of the set of AQDMs may be updated such that the updated key no longer matches the shared key of one or more hosts.

The shared keys may be used to establish a secure communication session. During a secure communication session, some embodiments may generate and utilize rotating keys.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a hardware system according to an exemplary embodiment;

FIG. 2 illustrates a message flow diagram used by an authentication algorithm of some embodiments;

FIG. 3 illustrates a message flow diagram used by an encrypted communication algorithm of some embodiments;

FIG. 4 illustrates a flow chart of an exemplary process that updates security keys;

FIG. 5 illustrates a flow chart of an exemplary process that establishes and conducts secure communication sessions; and

FIG. 6 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to securely communicate across detection and monitoring systems, such as air quality detection and monitoring systems.

A first exemplary embodiment provides a detection and monitoring system comprising: at least one host; and a plurality of detection modules, wherein the at least one host and the plurality of detection modules communicate across an encrypted channel using a shared key.

A second exemplary embodiment provides an automated method that provides secure communications, the method comprising: receiving, at a detection module, a session request message sent from a host device; sending, from the detection module to the host device, a session create message; and receiving, at the detection module, a session accept message sent from the host device.

A third exemplary embodiment provides an automated method of enabling communication in a detection and monitoring system, the method comprising: identifying, at a server, a set of detection modules; identifying, at the server, a set of hosts; generating, at the server, an updated secret shared key; and pushing the updated shared secret key from the server to the set of detection modules and the set of hosts using an encrypted channel.

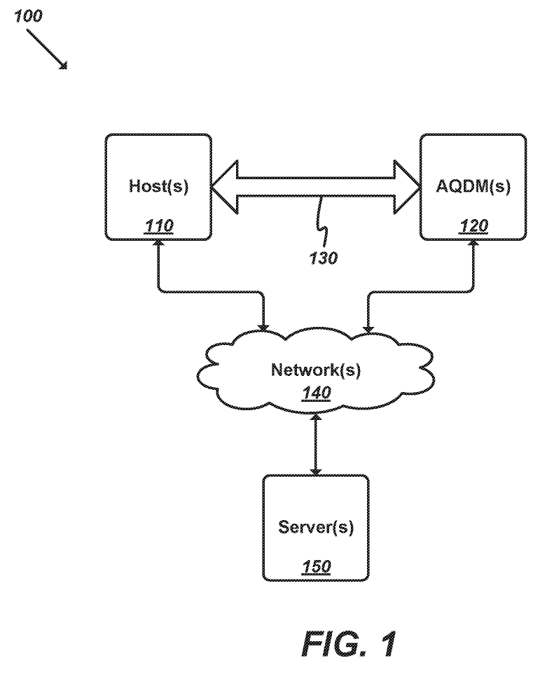

FIG. 1 illustrates a schematic block diagram of a hardware system according to an exemplary embodiment. As shown, the system may include one or more hosts 110, one or more AQDMs 120, communication links 130, network paths 140, and servers 150.

Different embodiments may include different numbers of elements and/or additional or fewer elements. In addition, various elements (or sets of elements) may be associated with other elements (or sets of elements), based on some relevant criteria. For instance, a first set of hosts 110 may be associated with a first set of AQDMs 120 while a second set of hosts 110 may be associated with a second set of AQDMs 120.

Such associations may be managed using shared keys among sets of devices. Thus, for instance, the first set of hosts 110 and first set of AQDMs 120 may utilize a first shared key while the second set of hosts 110 and second set of AQDMs 120 may utilize a second shared key.

Each host 110 may be an electronic device such as a smartphone, tablet, personal computer, etc. that is able to communicate with one or more AQDMs 120 and/or severs 150.

Each AQDM 120 may an electronic device that is able to communicate with the host 110 and server 150. The AQDM 120 may include various receivers, transmitters, wired connections, etc. that may allow the module to communicate with the other components.

The secure communication channels 130 may be established using the shared key. Such channels may include various physical devices, wireless links, interfaces, networks, etc., as appropriate.

The set of networks 140 may include various communications pathways including wired connections, wireless connections, cellular connections, etc. In some embodiments, the secure channels 130 may be provided at least partly by networks 140. In some embodiments, modules 120 may access the networks 140 via one or more secure channels 130 and one or more associated hosts 110 (e.g., the hosts may provide Internet connectivity to the modules).

The server 150 may be an electronic device that is able to communicate with the hosts 110 and/or AQDMs 120 across the networks 140. Such communication may be secure and may use different shared keys than are used among the hosts and AQDMs.

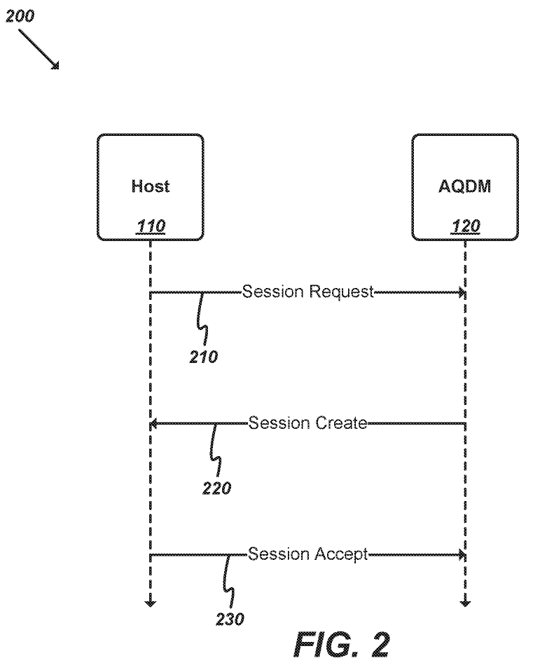

FIG. 2 illustrates a message flow diagram used by an authentication algorithm 200 of some embodiments. As shown, the algorithm includes messages sent between a host 110 and AQDM 120, such as those described above. Different embodiments may include other elements (e.g., server 150). The host 110 and AQDM 120 may have a shared secret key that may be pre burned to a physically non-rewritable storage of the AQDM. In some embodiments, the shared secret may be able to be updated, as described below in reference to process 400.

The algorithm 200 may be initiated by the host 110, based on various relevant criteria (e.g., based on user selection, elapsed time since last update, etc.). The host may send a “session request” message 210, which may be unencrypted. The session request message may include a host identifier and/or other relevant information.

The AQDM 120 may then validate the host. Such validation may include, for instance, comparing the host identifier to a list of valid hosts included in a look-up table, database, etc. The AQDM may then generate a “session create” message 220 that may include challenge content, a rotating key, and/or other relevant data. Next, the AQDM 120 may encrypt the “session create” message 220 with the shared secret key.

Next, the AQDM 120 may send the message 220 to the host 110. The host may then decrypt the message using the shared secret key. The host may then process the challenge content, store the rotating key, create a “session accept” message 230 which includes the challenge response, and then encrypt the message 230 using the shared secret key.

The host 110 may then send the “session accept” message 230 to the AQDM 120 which may validate the response and the algorithm 200 may end.

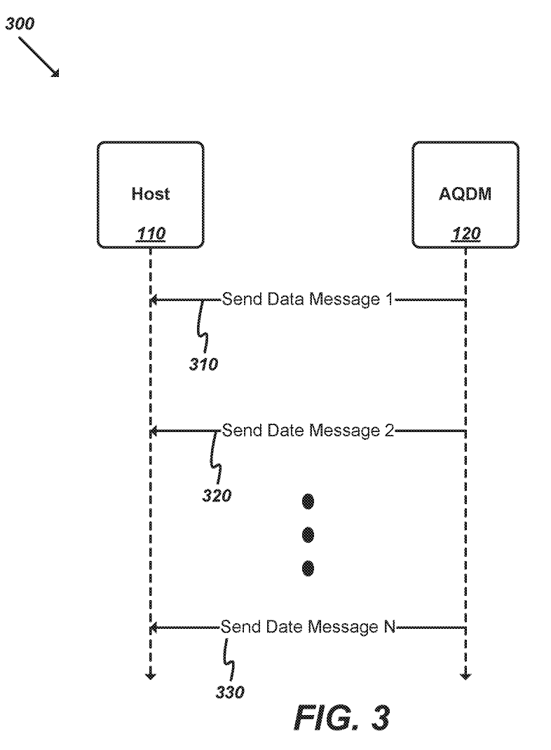

FIG. 3 illustrates a message flow diagram used by an encrypted communication algorithm 300 of some embodiments. Algorithm 300 may follow an authentication algorithm such as that described above in reference to algorithm 200.

As shown, the algorithm 300 includes messages sent between a host 110 and AQDM 120, such as those described above. Different embodiments may include other elements (e.g., server 150). Following algorithm 200, the host 110 and AQDM 120 may each have a first rotating key.

Algorithm 300 may be initiated by the AQDM 120. The AQDM may create a first data message 310. The message may include various data items (e.g., fine particulate matter information such as “PM 2.5” data, other air quality data, environmental data, timestamp information, etc.) and a second rotating key. Next, the AQDM 120 may encrypt the message 310 using the first rotating key. The AQDM 120 may then send the message 310 to the host 110.

Next, the host may decrypt the message using the first rotating key, read the data items, and store the second rotating key. In some embodiments the received data items may be sent to another resource (e.g., server 150) for processing.

The AQDM may then create a second data message 320. The message may include various data items (e.g., PM 2.5 data, timestamp information, etc.) and a third rotating key. Next, the AQDM 120 may encrypt the message 320 using the second rotating key. The AQDM 120 may then send the message 320 to the host 110.

Next, the host may decrypt the message using the second rotating key, read the data items, and store the third rotating key.

The algorithm 300 may continue as such for an arbitrary number of messages 330 where each message is encrypted (and decrypted) using the Nth rotating key, and the message includes the next rotating key, such that each rotating key is used for a single encryption/decryption cycle. Such a rotating key algorithm 300 provides more efficient processing and more secure data protection.

If the host 110 becomes out of sync with the AQDM 120 or is otherwise unable to decrypt data, the host 110 may initiate an algorithm such as algorithm 200 to restart the security protocol.

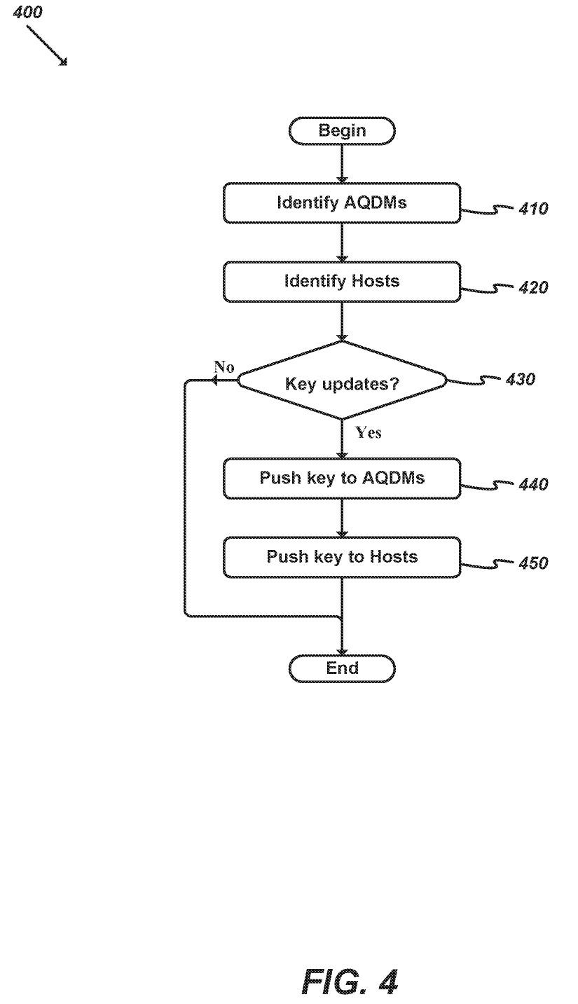

FIG. 4 illustrates a flow chart of an exemplary process 400 that updates security keys. Such a process may be performed by a resource such as server 150 described above. A complementary process may be performed by a resource such as host 110 or AQDM 120 described above.

As shown, the process may identify (at 410) a set of AQDMs. The AQDMs may be identified based on various relevant criteria (e.g., location, manufacturer, type, model, etc.) using various appropriate resources (e.g., a database, a look-up table, etc.).

Next, the process may identify (at 420) a set of hosts. Such hosts may be identified based on various relevant factors (e.g., location, association to the set of AQDMs, etc.) using various appropriate resources (e.g., a database, a look-up table, etc.).

The process may then determine (at 430) whether any key updates are needed. Such a determination may be made based on various relevant factors (e.g., data regarding a set of AQDMs, user selections, maintenance schedules, etc.). If no key updates are needed, the process may end.

If the process determines that key updates are needed, the process may further determine which resources require updates. For example, some updates may be sent to AQDMs only. Some updates may be sent to hosts only. Updates may be sent to a sub-set of AQDMs, to a sub-set of hosts, etc.

Next, the process may push (at 440) the updated keys to the identified AQDMs, push (at 450) the updated keys to the identified hosts, and then may end. Such updates may be pushed over various appropriate communication resources (e.g., using the “cloud”) such that the modules of a distributed system may be updated. The push operation may include establishment of a secure channel between the server and the modules or hosts. Such a secure channel may be established using an algorithm similar to algorithm 200 described above. In addition, the data may be pushed using an algorithm similar to algorithm 300 described above, where the messages are sent from the server to the modules or hosts.

In this way, communication (and thus access) between the hosts and AQDMs may be enabled or disabled.

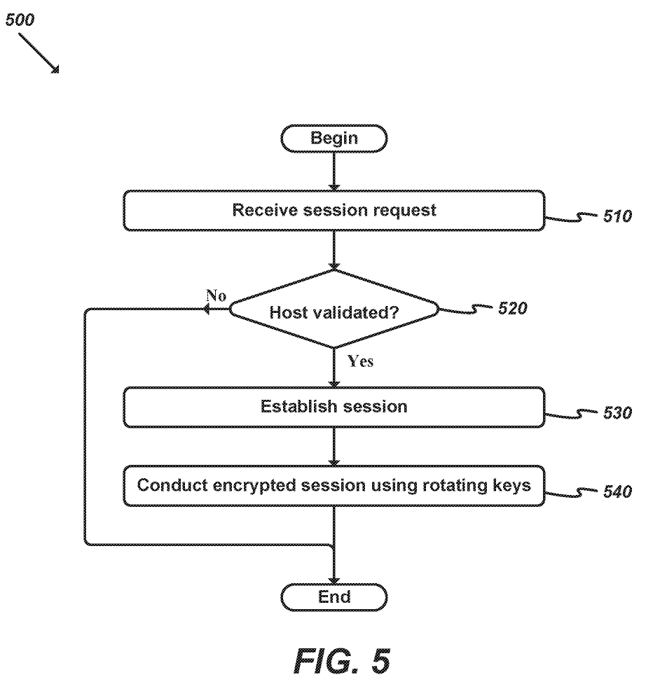

FIG. 5 illustrates a flow chart of an exemplary process 500 that establishes and conducts secure communication sessions. Such a process may be performed by a resource such as AQDM 120 described above. A complementary process may be performed by a resource such as host 110 described above.

As shown, the process may receive (at 510) a session request. Such a request may be received from a resource such as host 110 or server 150 described above. The process may then determine (at 520) whether the session request is valid. Such a determination may be based upon evaluation of the request using a shared secret key and an algorithm such as algorithm 200 described above. If the process 500 determines that the request is not valid, the process may end.

If the process determines that the request is valid, the process may establish (at 530) a communication session, conduct (540) the session using rotating keys as described above in reference to algorithm 300, and then may end.

In some embodiments, the processes 400 and 500 described above may be performed by different elements. For instance, a process similar to process 500 may be used to validate a server or other resource than a host.

Many of the algorithms, processes, and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

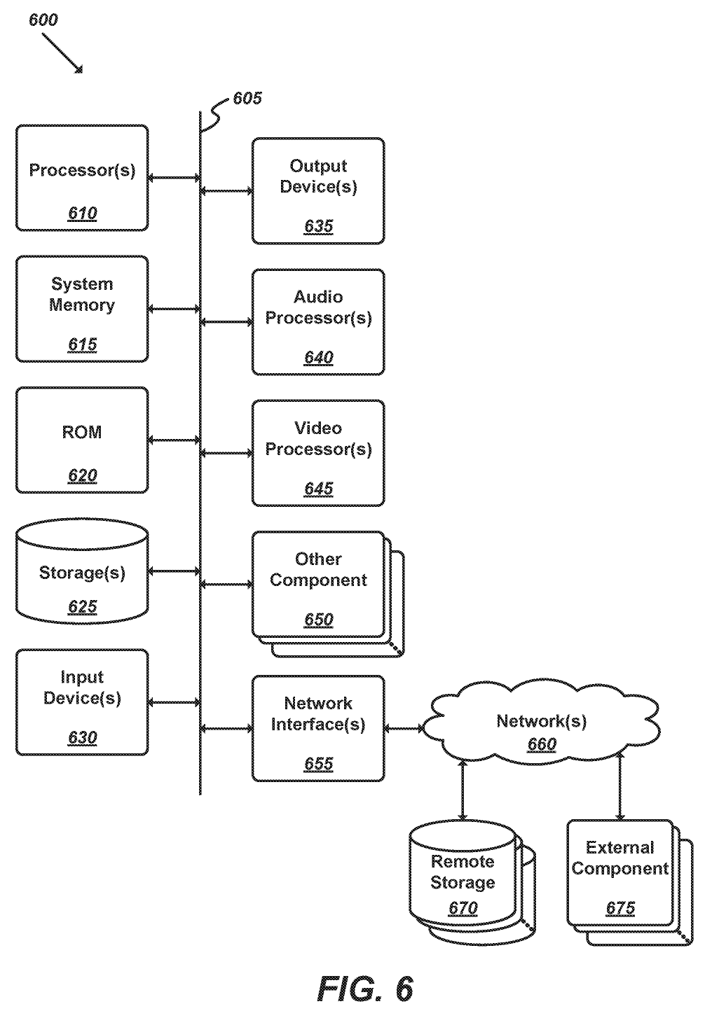

FIG. 6 illustrates a schematic block diagram of an exemplary computer system 400 used to implement some embodiments. For example, the system described above in reference to FIG. 1 may be at least partially implemented using computer system 600. As another example, the algorithms and processes described in reference to FIGS. 2, 3, 4 and 5 may be at least partially implemented using sets of instructions that are executed using computer system 600.

Computer system 600 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 600 may include at least one communication bus 605, one or more processors 610, a system memory 615, a read-only memory (ROM) 620, permanent storage devices 625, input devices 630, output devices 635, audio processors 640, video processors 645, various other components 650, and one or more network interfaces 655.

Bus 605 represents all communication pathways among the elements of computer system 600. Such pathways may include wired, wireless, optical, and/or other appropriate communication pathways. For example, input devices 630 and/or output devices 635 may be coupled to the system 600 using a wireless connection protocol or system.

The processor 610 may, in order to execute the processes of some embodiments, retrieve instructions to execute and/or data to process from components such as system memory 615, ROM 620, and permanent storage device 625. Such instructions and data may be passed over bus 605.

System memory 615 may be a volatile read-and-write memory, such as a random access memory (RAM). The system memory may store some of the instructions and data that the processor uses at runtime. The sets of instructions and/or data used to implement some embodiments may be stored in the system memory 615, the permanent storage device 625, and/or the read-only memory 620. ROM 620 may store static data and instructions that may be used by processor 610 and/or other elements of the computer system.

Permanent storage device 625 may be a read-and-write memory device. The permanent storage device may be a non-volatile memory unit that stores instructions and data even when computer system 600 is off or unpowered. Computer system 600 may use a removable storage device and/or a remote storage device as the permanent storage device.

Input devices 630 may enable a user to communicate information to the computer system and/or manipulate various operations of the system. The input devices may include keyboards, cursor control devices, audio input devices and/or video input devices. Output devices 635 may include printers, displays, audio devices, etc. Some or all of the input and/or output devices may be wirelessly or optically connected to the computer system 600.

Audio processor 640 may process and/or generate audio data and/or instructions. The audio processor may be able to receive audio data from an input device 630 such as a microphone. The audio processor 640 may be able to provide audio data to output devices 640 such as a set of speakers. The audio data may include digital information and/or analog signals. The audio processor 640 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 645 (or graphics processing unit) may process and/or generate video data and/or instructions. The video processor may be able to receive video data from an input device 630 such as a camera. The video processor 645 may be able to provide video data to an output device 640 such as a display. The video data may include digital information and/or analog signals. The video processor 645 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 650 may perform various other functions including providing storage, interfacing with external systems or components, etc.

Finally, as shown in FIG. 6, computer system 600 may include one or more network interfaces 655 that are able to connect to one or more networks 660. For example, computer system 600 may be coupled to a web server on the Internet such that a web browser executing on computer system 600 may interact with the web server as a user interacts with an interface that operates in the web browser. Computer system 600 may be able to access one or more remote storages 670 and one or more external components 675 through the network interface 655 and network 660. The network interface(s) 655 may include one or more application programming interfaces (APIs) that may allow the computer system 600 to access remote systems and/or storages and also may allow remote systems and/or storages to access computer system 600 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 600 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

We claim:

1. A detection and monitoring system (100) comprising:
at least one host (110); and
a plurality of detection modules (120),
wherein the at least one host and the plurality of detection modules communicate across an encrypted channel (130) using a shared key.

2. The detection and monitoring system of claim 1, wherein the at least one host and the at least one detection module communicate across the encrypted channel using a rotating key algorithm.

3. The detection and monitoring system of claim 1, wherein an updated shared key is provided to a set of detection modules from the plurality of detection modules such that the set of detection modules is able to communicate across the encrypted channel using the updated shared key.

4. The detection and monitoring system of claim 1 further comprising a server that communicates with the at least one host and the plurality of detection modules across the encrypted channel.

5. The detection and monitoring system of claim 1, wherein the encrypted channel comprises at least one wireless link.

6. The detection and monitoring system of claim 1, wherein the plurality of detection modules comprises an air quality detection module.

7. An automated method that provides secure communications, the method comprising:
receiving, at a detection module (120), a session request message (210) sent from a host device (110);
sending, from the detection module to the host device, a session create message (220); and
receiving, at the detection module, a session accept message (230) sent from the host device.

8. The automated method of claim 7 further comprising encrypting, at the detection module, the session create message using a shared secret key, wherein the session create message comprises a first rotating key and challenge content.

9. The automated method of claim 8 further comprising:
decrypting, at the host device, the session create message using the shared secret key;
storing, at the host device, the first rotating key;
generating, at the host device, a challenge response based at least partly on the challenge content; and
encrypting the session accept message using the shared secret key, wherein the session accept message comprises the challenge response.

10. The automated method of claim 9 further comprising:
generating, at the detection module, a first data message;
encrypting, at the detection module, the first data message using the first rotating key; and
sending the first data message from the detection module to the host, wherein the first data message comprises a second rotating key.

11. The automated method of claim 10 further comprising:
decrypting, at the host device, the first data message using the first rotating key; and
storing, at the host device, the second rotating key.

12. The automated method of claim 11 further comprising:
generating, at the detection module, a second data message;
encrypting, at the detection module, the second data message using the second rotating key; and
sending the second data message from the detection module to the host, wherein the second data message comprises a third rotating key.

13. The automated method of claim 12 further comprising:
decrypting, at the host device, the second data message using the second rotating key; and
storing, at the host device, the third rotating key.

14. An automated method of enabling communication in a detection and monitoring system, the method comprising:
identifying (410), at a server, a set of detection modules (120);
identifying (420), at the server (150), a set of hosts (110);
generating (430), at the server, an updated secret shared key; and
pushing (440-450) the updated shared secret key from the server to the set of detection modules and the set of hosts using an encrypted channel (130).

15. The automated method of claim 14 further comprising:
establishing a first secure connection between the server and the set of detection modules using a shared secret key; and
establishing a second secure connection between the server and the set of hosts using the shared secret key.

16. The automated method of claim 14, wherein the set of detection modules is a sub-set of available detection modules.

17. The automated method of claim 16 further comprising establishing a third secure connection between the server and the set of detection modules using the updated shared key.

18. The automated method of claim 14 further comprising establishing a secure connection between the set of hosts and the set of detection modules using the updated shared secret key.

19. The automated method of claim 14, wherein the encrypted channel comprises at least one wireless link.

20. The automated method of 14, wherein the set of detection modules comprises an air quality detection module.
